(19) United States
(12) Patent Application Publication
(10) Pub. No.: US 2011/0083027 A1
(43) Pub. Date: Apr. 7, 2011

(54) CONTROLLER FOR IMAGE PROCESSING APPARATUS

(75) Inventor: Toshimitsu Takagi, Shimosuwa-machi (JP)

(73) Assignee: SEIKO EPSON CORPORATION, Shinjuku-ku (JP)

(21) Appl. No.: 12/898,601

(22) Filed: Oct. 5, 2010

(30) Foreign Application Priority Data
Oct. 5, 2009 (JP) 2009-231877
May 26, 2010 (JP) 2010-120090

(51) Int. Cl. G06F 1/32

(52) U.S. Cl. 713/323

(57) ABSTRACT

A controller for an image processing apparatus, which has a function of switching a plurality of operation modes, includes a CPU of which number of times the power is turned ON/OFF in a range where operations are guaranteed is previously defined, a processor which performs a specified processing, a sub CPU, and other devices, the controller having a normal mode, a first power saving mode in which the power consumption is smaller than that in the normal mode, a second power saving mode in which the power consumption is smaller than that in the first power saving mode, and a third power saving mode in which the power consumption is smaller than that in the second power saving mode.

### BACKGROUND

1. Technical Field

The present invention relates to an image processing apparatus such as a printer, a copying machine, a multifunction peripheral, a scanner and the like, and a controller for the image processing apparatus. In particular, the invention relates to a power saving technique of an image processing apparatus and a controller for the image processing apparatus.

2. Related Art

There is an image processing apparatus having a normal mode in which functions of the image processing apparatus such as printing, copying, or the like can be executed and a mode in which power consumption is smaller than that in the normal mode (hereinafter, referred to as “power saving mode”). In the power saving mode, power supply to some devices (for example, print engine, CPU, HDD, and DRAM) in the image processing apparatus is turned OFF, or some devices are set to be in a sleep state. This makes it possible to decrease power consumption in the power saving mode in comparison with that in the normal mode.

For example, in JP-A-2008-55633, an image forming apparatus in which power of an HDD is turned OFF at the time of shifting to the power saving mode.

In recent years, power consumption of an image processing apparatus is desired to be further decreased. In addition, speeding-up of processings by the image processing apparatus is also desired.

However, various problems arise if both power saving and speeding-up of processings are to be achieved. For example, when a CPU of which processing speed is much faster is used, power consumption tends to be increased. Further, in a CPU of which processing speed is much faster, the number of times the power thereof is turned ON/OFF is limited in some case in a viewpoint of reliability or operation guarantee. If power of such CPU is turned OFF in a power saving mode, there is a risk that reliability is deteriorated.

### SUMMARY

An advantage of some aspects of the invention is to provide a technique of properly achieving both power saving and speeding-up of processings in an image processing apparatus.

A controller for an image processing apparatus according to a first aspect of the invention, which has a function of switching a plurality of operation modes, includes a CPU of which number of times the power is turned ON/OFF in a range where operations are guaranteed is previously defined, a processor which performs a specified processing, a sub CPU, and other devices, the controller having a normal mode, a first power saving mode in which the power consumption is smaller than that in the normal mode, a second power saving mode in which the power consumption is smaller than that in the first power saving mode, and a third power saving mode in which the power consumption is smaller than that in the second power saving mode. In the controller for the image processing apparatus, in the normal mode, the CPU, the processor and the other devices are in an ON state where each normal function can be executed, and the sub CPU is in a sleep state in which the power consumption is smaller than that in the ON state; in the first power saving mode, the CPU is in the sleep state, at least one of the processor and the other devices is in the sleep state, and the sub CPU is in the ON state; in the second power saving mode, the CPU is in the sleep state, the processor and the other devices are in a power OFF state, and the sub CPU is in the ON state; in the third power saving mode, the CPU is in the power OFF state, the processor and the other devices are in the power OFF state, and the sub CPU is in the ON state; the CPU controls switching from the normal mode to the first power saving mode; the sub CPU controls switching from the first power saving mode to the normal mode, switching from the first power saving mode to the second power saving mode and the third power saving mode, and switching from the second power saving mode and the third power saving mode to the normal mode; and the sub CPU determines whether to switch from the first power saving mode to either of the second power saving mode or the third power saving mode in accordance with a cumulative number of times the power of the CPU is turned ON/OFF.

In the above controller for the image processing apparatus, it is preferable that the sub CPU determine whether the cumulative number of times the power of the CPU is turned ON/OFF is not larger than a predetermined number, and if the cumulative number of times is not larger than the predetermined number, the sub CPU switch from the first power saving mode to the second power saving mode, and if the cumulative number of times is larger than the predetermined number, the sub CPU switch from the first power saving mode to the third power saving mode.

In the above controller for the image processing apparatus, in which the image processing apparatus is a print apparatus, it is preferable that the sub CPU calculate a ratio of a remaining number of times the power of the CPU is turned ON/OFF as a first ratio by using the cumulative number of times the power of the CPU is turned ON/OFF and the number of times the power of the CPU is turned ON/OFF in a range where operations are guaranteed, and calculate a ratio of a remaining number of printable sheets as a second ratio by using a cumulative number of printed sheets and a predetermined number of printable sheets, the sub CPU determine whether the first ratio is larger than the second ratio, and if the first ratio is larger than the second ratio, the sub CPU switch from the first power saving mode to the third power saving mode, and if the first ratio is not larger than the second ratio, the sub CPU switch from the first power saving mode to the second power saving mode.

A controller for an image processing apparatus according to a second aspect of the invention, which has a function of switching a plurality of operation modes, includes a CPU of which number of times the power is turned ON/OFF in a range where operations are guaranteed is previously defined, a processor which performs a specified processing, a sub CPU, and other devices, the controller having a normal mode, a second power saving mode in which the power consumption is smaller than that in the normal mode, and a third power saving mode in which the power consumption is smaller than that in the second power saving mode. In the controller for the image processing apparatus, in the normal mode, the CPU, the processor and the other devices are in an ON state where each normal function can be executed, and the sub CPU is in a sleep state in which the power consumption is smaller than that in an ON state; in the second power saving mode, the CPU is in the sleep state, the processor and the other devices are in a power OFF state, and the sub CPU is in the ON state; in the third power saving mode, the CPU is in the power OFF state, the processor and the other devices are in the power OFF state, and the sub CPU is in the ON state; the CPU controls switching from the normal mode to the second power saving mode; the sub CPU controls switching from the second power saving mode to the normal mode, switching from the second power saving mode to the third power saving mode, and switching from the third power saving mode to the normal mode; and the sub CPU determines whether to continue the second power saving mode or switch from the second power saving mode to the third power saving mode in accordance with a cumulative number of times the power of the CPU is turned ON/OFF.

In the above controller for the image processing apparatus, it is preferable that the sub CPU determine whether the cumulative number of times the power of the CPU is turned ON/OFF is not larger than a predetermined number, and if the cumulative number of times is not larger than the predetermined number, the sub CPU switch from the second power saving mode to the third power saving mode, and if the cumulative number of times is larger than the predetermined number, the sub CPU continue the second power saving mode.

In the above controller for the image processing apparatus, in which the image processing apparatus is a print apparatus, it is preferable that the sub CPU calculate a ratio of a remaining number of times the power of the CPU is turned ON/OFF as a first ratio by using the cumulative number of times the power of the CPU is turned ON/OFF and the number of times the power of the CPU is turned ON/OFF in a range where operations are guaranteed, and calculate a ratio of a remaining number of printable sheets as a second ratio by using a cumulative number of printed sheets and a predetermined number of printable sheets, the sub CPU determine whether the first ratio is larger than the second ratio, if the first ratio is larger than the second ratio, the sub CPU switch from the second power saving mode to the third power saving mode, and if the first ratio is not larger than the second ratio, the sub CPU continue the second power saving mode.

In the above controller for the image processing apparatus, it is preferable that the sub CPU transmit a reset signal to the CPU when switching from the second power saving mode to the normal mode. Further, it is preferable that the sub CPU transmit a reset signal before switching from the second power saving mode to the normal mode, and stop the transmission of the reset signal at the time of switching.

In the above controller for the image processing apparatus, it is preferable that the CPU and the processor be connected to each other with a signal line for inputting an interrupt signal to the CPU, and an input terminal of the interrupt signal on the CPU be pulled up.

A printer, a scanner, a copying machine, or a multifunction peripheral according to a third aspect of the invention includes the controller for the image processing apparatus according to any one of the above aspects.

### BRIEF DESCRIPTION OF THE DRAWINGS

The invention will be described with reference to the accompanying drawings, wherein like numbers reference like elements.

FIG. 1 is a diagram illustrating a schematic configuration of a printer controller according to an embodiment of the invention.

FIG. 2 is a diagram illustrating an Operation Mode Example 1 of the printer controller.

FIG. 3 is a flowchart illustrating a shift processing of various types of operation modes in the printer controller in the Operation Mode Example 1.

FIG. 4 is a diagram illustrating an Operation Mode Example 2 of the printer controller.

FIG. 5 is a flowchart illustrating a shift processing of various types of operation modes in the printer controller in the Operation Mode Example 2.

### DESCRIPTION OF EXEMPLARY EMBODIMENTS

Hereinafter, an embodiment of the invention will be described.

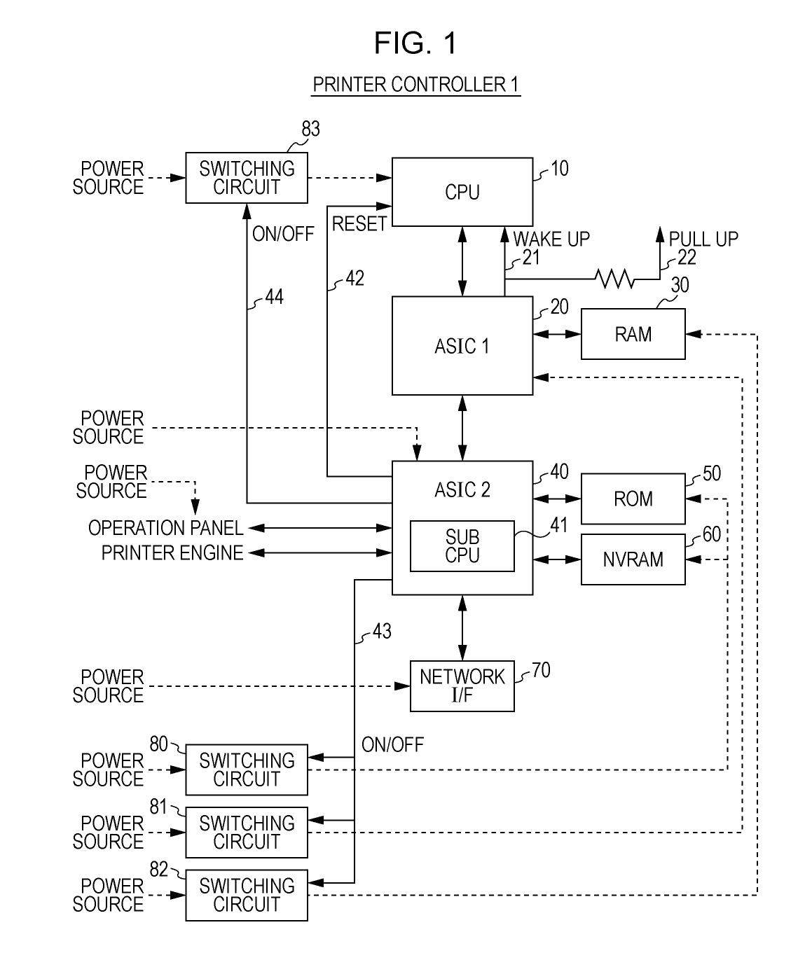

FIG. 1 is a block diagram illustrating a schematic configuration of a printer controller 1 according to an embodiment of the invention. In the embodiment, a printer is described as an example of an image processing apparatus, and a printer controller is described as an example of a controller. It is needless to say that the image processing apparatus is not limited to the printer and may be a copying machine, a multifunction peripheral, a scanner or the like.

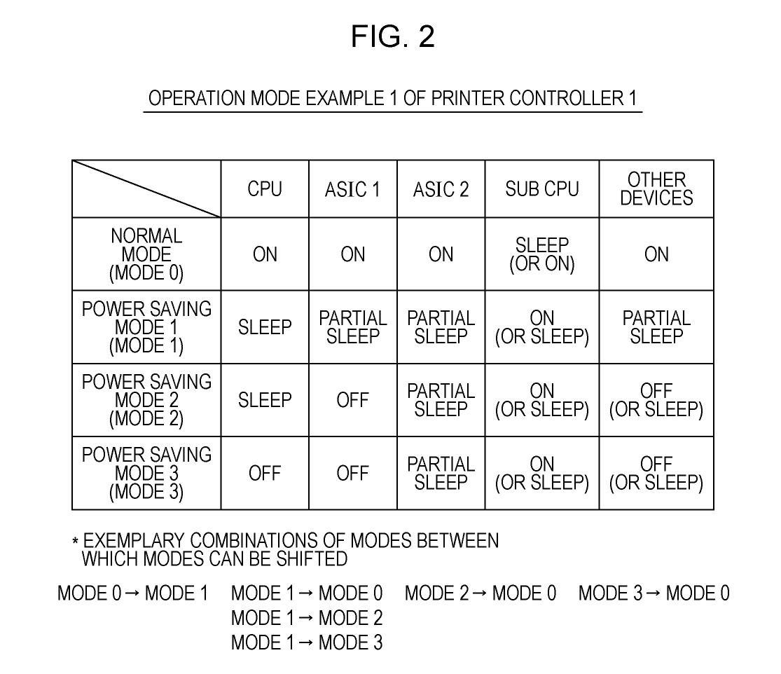

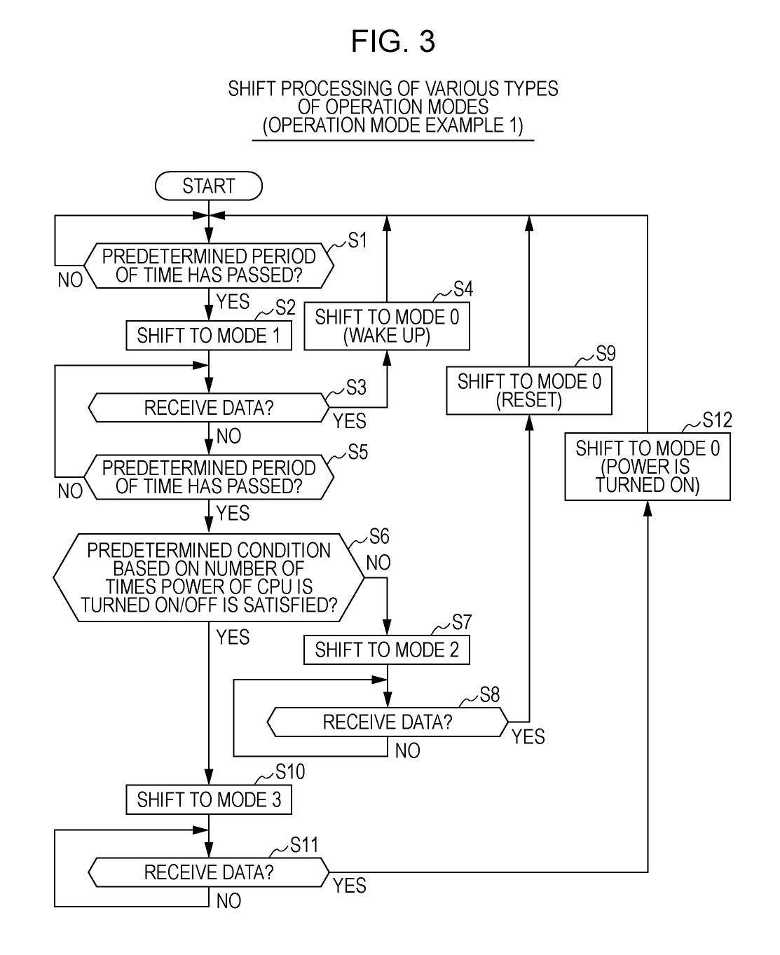

The printer controller 1 is mounted on a printer (not shown) and integrally controls the printer so as to realize various types of functions of the printer. Further, as described below with reference to FIG. 2 and FIG. 3, the printer controller 1 has a plurality of operation modes and performs power control depending on each mode. It is to be noted that the printer is an ink jet printer or a laser printer, for example.

The printer controller 1 has a CPU 10, an Application Specific Integrated Circuit (ASIC) 20, a RAM 30, an ASIC 40, a ROM 50, a Non-Volatile RAM (NVRAM) 60, a network interface (I/F) 70, and switching circuits 80 through 83. The ASIC 40 has a sub CPU 41.

The CPU 10 is a main arithmetic device which controls the printer controller 1 and the entire printer. In the embodiment, an upper limit value of the number of times the power of the CPU 10 is turned ON/OFF is defined as a specification. Up to the upper limit value thereof, reliability and operations of the CPU 10 are guaranteed. Further, the CPU 10 has a sleep mode in which power consumption is smaller than that in a normal operation mode.

Further, as described below with reference to FIG. 2 and FIG. 3, the CPU 10 controls the printer controller 1 so as to shift from the normal mode to the power saving mode.

The ASIC 20 (ASIC 1) has a CPU interface, a memory interface, an interface connected to the ASIC 40, an image processing circuit and the like. The ASIC 20 is a device which executes an access control to the RAM 30, an image processing in order to generate print data for transmitting to the printer engine, and the like. The ASIC 20 has a sleep mode in which power consumption of at least some devices on the ASIC 20 (memory, processing circuit, and the like) is made smaller than that in the normal operation mode.

Further, the ASIC 20 is connected to the CPU 10 with a signal line 21 for transmitting an interrupt signal (wake-up signal) to the CPU 10. The interrupt signal is a signal for requiring a wake-up processing of the CPU 10. An input terminal of the signal line 21 on the CPU 10 is pulled-up in order to make potential stable when a power of the ASIC 20 is turned OFF. It is to be noted that the wake-up processing is a processing by which the CPU 10 (a program executed by the CPU 10) returns to a state immediately before shifting to the sleep mode.

The RAM 30 is a volatile memory which temporarily stores programs executed by the CPU 10, image data to be image-processed, and the like. The RAM 30 is a DDR-SDRAM, for example. The RAM 30 has a sleep mode (for example, self refresh mode) in which power consumption is smaller than that in the normal operation mode and a mode (for example, power-down mode) in which power consumption is made much smaller by stopping an internal clock.

The ASIC 40 (ASIC 2) is a device which controls various types of input/output (I/O) devices and I/F devices such as the ROM 50, the NVRAM 60, the network I/F 70, the operation panel, and the printer engine. The ASIC 40 has a sleep mode in which power consumption of at least some devices (memory, processing circuit, and the like) on the ASIC 40 is made smaller than that in the normal operation mode. For example, the ASIC 40 transfers information output from the I/O devices and the I/F devices to the CPU 10 or the RAM 30, or transfers information transmitted from the CPU 10 to various types of the I/O devices and the I/F devices.

Further, the ASIC 40 is connected to the CPU 10 with a signal line 42 for transmitting a reset signal. The reset signal is a signal for requiring the CPU 10 to perform a reset processing. The reset processing is a processing by which the CPU 10 (program executed by the CPU 10) returns to an initial state by resetting a program counter or the like, for example.

The ASIC 40 is connected to each of the switching circuits 80 through 82 with signal lines 43 for transmitting signals for switching ON/OFF of the switching circuits 80 through 82. Further, the ASIC 40 is connected to the switching circuit 83 with a signal line 44 for transmitting signals for switching ON/OFF of the switching circuit 83.

The sub CPU 41 is an arithmetic device which controls the printer controller 1 so as to shift the operation modes. As will be described below with reference to FIG. 2 and FIG. 3, the sub CPU 41 controls the printer controller 1 so as to shift from a power saving mode to another power saving mode, and from a power saving mode to the normal mode.

Further, the sub CPU 41 has a sleep mode in which power consumption is smaller than that in the normal operation mode. Since the sub CPU 41 mainly performs a processing relating to shifting of the operation modes, processing speed of the sub CPU 41 is not required to be faster and the sub CPU 41 is not required to be highly functional in comparison with the CPU 10.

The ROM 50 and the NVRAM 60 are nonvolatile memories storing programs and setting data which should be continuously held even if the power of the printer is turned OFF. The ROM 50 is a flush ROM, for example. The NVRAM 60 is a circuit having a small battery and an SRAM, for example.

The network I/F 70 is a device which communicates with an external device (for example, a computer installed with a printer driver program) via a network.

The switching circuit 80 is controlled by the sub CPU 41 via the signal line 43 so as to turn ON/OFF the power supply to the ROM 50 and the NVRAM 60. The switching circuit 81 is controlled by the sub CPU 41 via the signal line 43 so as to turn ON/OFF the power supply to the ASIC 20. The switching circuit 82 is controlled by the sub CPU 41 via the signal line 43 so as to turn ON/OFF the power supply to the RAM 30. The switching circuit 83 is controlled by sub CPU 41 via the signal line 44 so as to turn ON/OFF the power supply to the CPU 10.

A schematic configuration of the printer controller 1 has been described above. However, a main configuration has been described in order to explain characteristics of the invention and the printer controller is not limited to the above configuration. Further, it is not intended that other configurations included in a typical image processing apparatus are excluded.

For example, the switching circuits 80 through 83 may be included in the ASIC 40. Further, the network I/F 70 may be separated from the printer controller 1. Each of the ROM 50 and the NVRAM 60 may be connected to the ASIC 20. The printer engine may be connected to the ASIC 20. Devices such as a USB I/F, a serial I/F, and an HDD may be connected to the ASIC 40. Further, the ASIC 20 and the ASIC 40 may be integrated.

Next, various types of operation modes and control of shifting between the various types of modes realized in the above printer controller 1 are described.

### Operation Mode Example 1

FIG. 2 is a diagram illustrating an Operation Mode Example 1 of the printer controller 1.

The printer controller 1 has four modes (“normal mode (mode 0)”, “power saving mode 1 (mode 1)”, “power saving mode 2 (mode 2)”, “power saving mode 3 (mode 3)”).

In FIG. 2, “ON” indicates a state where power is supplied to a corresponding device and various types of normal functions of the device can be executed. “Sleep” indicates a state where the power is supplied to a corresponding device but the sleep mode is executed in the device. “Partial Sleep” indicates a state where at least some devices on the ASIC 20 or the ASIC 40 or at least one of other devices (RAM 30, ROM 50, and NVRAM 60) execute the sleep mode. “OFF” indicates a state where power supply to a corresponding device is shut off.

In the “normal mode (mode 0)”, the CPU 10=ON, the ASIC 20=ON, the ASIC 40=ON, the sub CPU 41=Sleep (or ON), and other devices=ON are set.

In the “power saving mode 1 (mode 1)”, the CPU 10=Sleep, the ASIC 20=Partial Sleep, the ASIC 40=Partial Sleep, the sub CPU 41=ON (or Sleep), and other devices=Partial Sleep are set.

In the case of the power saving mode 1, at least one of the network I/F 70, the operation panel, and the printer engine may also be shifted to the sleep mode. However, in the sleep mode, the network I/F 70 monitors reception of predetermined data (for example, print data) indicating that at least the CPU 10 is to be operated in the normal mode. When the network I/F 70 receives the predetermined data, the network I/F 70 transfers the predetermined data to the sub CPU 41. In the same manner, the operation panel also monitors a predetermined user's operation (for example, operation of a button for cancelling power saving mode) indicating that at least the CPU 10 is to be operated in the normal mode. When the operation panel detects such operation, the operation panel notifies the sub CPU 41 of the detection.

In the “power saving mode 2 (mode 2)”, the CPU 10=Sleep, the ASIC 20=OFF, the ASIC 40=Partial Sleep, the sub CPU 41=ON (or Sleep), other devices=OFF (or Sleep) are set.

In the case of the power saving mode 2, at least one of the network I/F 70, the operation panel, and the printer engine may be shifted to a mode in which power consumption is smaller than that in the sleep mode or to the power OFF state. However, the network I/F 70 monitors reception of predetermined data indicating that at least the CPU 10 is to be operated in the normal mode. When the network I/F 70 receives the predetermined data, the network I/F 70 transfers the predetermined data to the sub CPU 41. In the same manner, the operation panel also monitors a predetermined user's operation indicating that at least the CPU 10 is to be operated in the normal mode. When the operation panel detects the operation, the operation panel notifies the sub CPU 41 of the detection.

In the “power saving mode 3(mode 3),” the CPU 10=OFF, the ASIC 20=OFF, the ASIC 40=Partial Sleep, the sub CPU 41=ON (or Sleep), other devices=OFF (or Sleep) are set. The power saving mode 3 is different from the power saving mode 2 in that the CPU 10 is set to be in the OFF state.

In the above plurality of modes, combinations of the modes between which modes can be shifted are mode 0 mode 1, mode 1 mode 0, mode 1 mode 2, mode 1 mode 3, mode 2 mode 0, mode 3 mode 0. In the Example, only the mode 1 can be shifted to the mode 2 and the mode 3.

As described above, in the embodiment, the CPU 10 is kept to be in the sleep mode and the power thereof is not turned OFF in the power saving mode 1 and the power saving mode 2. Therefore, the increase in the number of times the power of the CPU 10 is turned ON/OFF is limited as much as possible in both modes. Accordingly, reliability can be kept to be high for a longer period of time. Further, in the embodiment, when a predetermined condition described below is satisfied, the power saving mode 3 is used and the power of the CPU 10 is set to be in the OFF state. This makes it possible to achieve power saving further. In the embodiment, power of some devices other than the CPU 10 is set to be in the OFF state in the power saving mode 2 and the power saving mode 3. This makes it possible to achieve power saving even further.

In the cases of the power saving mode 2 and the power saving mode 3, devices with concern for deterioration in reliability due to the increase in the number of times the power is turned ON/OFF among devices other than the CPU 10 may be set to be in the sleep mode. With this, reliability of the printer and the entire printer controller can be kept to be high for a longer period of time.

FIG. 3 is a flowchart illustrating a shift processing of various types of operation modes in the printer controller 1 in the Operation Mode Example 1. The flow is executed in a state of the normal mode (mode 0) after the power of the printer is turned ON and the printer is started up.

In S1, the CPU 10 monitors whether a predetermined period of time has passed since the normal mode (mode 0) was started. To be more specific, the CPU 10 monitors by using a timer whether a predetermined period of time (for example, 15 minutes) has passed since an instruction to perform a processing in which a processing by the CPU 10 is required (for example, a processing relating to printing) was accepted for the last time. If the predetermined period of time has not passed (S1: NO), the CPU 10 continues monitoring. If the predetermined period of time has passed (S1: YES), the CPU 10 moves a process to S2.

It is to be noted that the monitoring condition is not limited to the above condition. The CPU 10 may monitor whether a user's operation of setting the power saving mode 1 has been accepted through the operation panel.

In S2, the CPU 10 performs a processing of shifting from the normal mode (mode 0) to the power saving mode 1 (mode 1). To be more specific, the CPU 10 requires the ASIC 20 and the ASIC 40 to shift to the sleep mode (Partial Sleep). Further, the CPU 10 requires the RAM 30 to shift to the sleep mode. Then, after the ASIC 20, the ASIC 40, and the RAM 30 have shifted to the sleep mode, the CPU 10 itself also shifts to the sleep mode and the process is moved to S3.

At this time, when the ASIC 20 has shifted to the sleep mode, the ASIC 20 stops a function of transmitting an interrupt signal so as not to transmit the interrupt signal to the CPU 10. Further, when the ASIC 40 has shifted to the sleep mode, the ASIC 40 makes the sub CPU 41 return to the ON state from the sleep mode.

In S3, the sub CPU 41 monitors whether predetermined data has been received. To be more specific, the sub CPU 41 monitors whether predetermined data (for example, print data transferred from the network I/F 70) indicating that at least the CPU 10 is to be operated in the normal mode has been received. If the predetermined data has been received (S3: YES), the sub CPU 41 moves a process to S4. If the predetermined data has not been received (S3: NO), the sub CPU 41 moves a process to S5.

It is to be noted that the monitoring condition is not limited to the above condition. The sub CPU 41 may monitor whether a user's operation of setting the normal mode has been accepted through the operation panel.

Further, in the above S3, although the sub CPU 41 executes monitoring, at least one of the ASIC 20 and the ASIC 40 may execute monitoring. That is to say, a predetermined circuit which is not in the sleep mode in at least one of the ASIC 20 and the ASIC 40 executes monitoring. At this time, the sub CPU 41 may be kept to be in the sleep mode.

In S4, the sub CPU 41 performs a processing of shifting from the power saving mode 1 (mode 1) to the normal mode (mode 0). To be more specific, the sub CPU 41 requires the ASIC 20, the ASIC 40, and the RAM 30 to shift to the ON state. After the ASIC 20, the ASIC 40, and the RAM 30 have shifted to the ON state, the sub CPU 41 itself shifts to the sleep mode, and returns a process to S1.

Note that after the ASIC 20, the ASIC 40, and the RAM 30 have shifted to the ON state, the ASIC 20 transmits a wake-up signal to the CPU 10 so as to make the CPU 10 execute a wake-up processing. The CPU 10 returns to the ON state so that the CPU 10 can execute a program from a state immediately before the printer controller 1 shifts to the power saving mode 1. At this time, the CPU 10 may output information indicating that the CPU 10 has returned to the normal mode 0 from the power saving mode 1 to the operation panel.

In S5, the sub CPU 41 monitors whether a predetermined period of time has passed since the power saving mode 1 (mode 1) was started. To be more specific, the sub CPU 41 monitors by using a timer whether a predetermined period of time (for example, 15 minutes) has passed since the printer controller shifted from the mode 0 to the mode 1. If the predetermined period of time has not passed (S5: NO), the sub CPU 41 returns a process to S3. If the predetermined period of time has passed (S5: YES), the sub CPU 41 moves a process to S6.

It is to be noted that the monitoring condition is not limited to the above condition. The sub CPU 41 may monitor whether a user's operation of setting the power saving mode 2 or the power saving mode 3, for example, has been accepted through the operation panel.

In S6, the sub CPU 41 determines whether a predetermined condition based on the number of times the power of the CPU 10 is turned ON/OFF is satisfied. Hereinafter, the determination is described in detail.

The printer controller 1 previously stores an upper limit value of the number of times the power of the CPU 10 is turned ON/OFF in a range where reliability and operations of the CPU 10 are guaranteed. The upper limit value is recorded in the ROM 50 or the NVRAM 60 at the time of manufacturing the printer, for example. Further, the printer controller 1 records a cumulative value of the number of times the power of the CPU 10 is turned ON/OFF. A recording method is as follows. For example, it is sufficient that the sub CPU 41 monitors that the power of the CPU 10 is turned ON/OFF, and the number of times thereof is accumulated in a storage region of the ROM 50 or the NVRAM 60.

By using the above various types of values, the sub CPU 41 determines whether the cumulative value of the number of times the power of the CPU 10 is turned ON/OFF is not larger than the predetermined upper limit value (condition is satisfied). If the cumulative value is not larger than the upper limit value (S6: YES), the sub CPU 41 moves a process to S10. If the cumulative value is larger than the upper limit value (S6: NO), the sub CPU 41 moves a process to S7.

In S7, the sub CPU 41 performs a processing of shifting from the power saving mode 1 (mode 1) to the power saving mode 2 (mode 2). To be more specific, the sub CPU 41 requires the ASIC 20, the RAM 30, the ROM 50, and the NVRAM 60 to shift to the OFF state. The ASIC 20, the RAM 30, the ROM 50, and the NVRAM 60 perform various types of setting processings for shifting to the OFF state. Thereafter, the sub CPU 41 transmits a signal for turning OFF the power to the switching circuits 80 through 82 and moves a process to S8. Note that since the processing is required to be continued by the sub CPU 41, the ASIC 40 is kept to be in the sleep mode (Partial Sleep).

In S8, the sub CPU 41 monitors whether predetermined data has been received. To be more specific, the sub CPU 41 monitors whether predetermined data (for example, print data transferred from the network I/F 70) indicating that at least the CPU 10 is to be operated in the normal mode has been received. If the predetermined data has been received (S8: YES), the sub CPU 41 moves a process to S9. If the predetermined data has not been received (S8: NO), the sub CPU 41 continues monitoring.

It is to be noted that the monitoring condition is not limited to the above condition. The sub CPU 41 may monitor whether a user's operation of setting the normal mode has been accepted through the operation panel.

In S9, the sub CPU 41 performs a processing of shifting from the power saving mode 2 (mode 2) to the normal mode (mode 0). To be more specific, the sub CPU 41 transmits a signal for turning ON the power to the switching circuits 80 through 82 and requires the ASIC 40 to shift to the ON state. When power is supplied to the ASIC 20, the RAM 30, the ROM 50, and the NVRAM 60, the ASIC 20, the RAM 30, the ROM 50, and the NVRAM 60 execute various types of start-up processings and shift to the ON state. At this time, the ASIC 20 suppresses the wake-up signal from being transmitted to the CPU 10. Further, the ASIC 40 also executes the start-up processing and shifts to the ON state. After various types of devices have shifted to the ON state, the sub CPU 41 itself shifts to the sleep mode, and returns a process to S1.

After various types of devices have shifted to the ON state, the ASIC 40 transmits a reset signal to the CPU 10. The CPU 10 returns to the ON state so that the CPU 10 can start a processing from the reset state. At this time, the CPU 10 may output information indicating that the CPU 10 has returned to the normal mode 0 from the power saving mode 2 to the operation panel. Note that in the case of resetting, the CPU 10 executes a program from an initial state. Therefore, the CPU 10 cannot distinguish the reset state from a case where the power of the CPU 10 is turned ON from the OFF state. Then, for example, it is sufficient that the following method is employed. That is, the sub CPU 41 transmits a signal indicating that the CPU 10 has returned from the power saving mode 2 to the CPU 10. Then, the CPU 10 determines that the CPU 10 has returned to the normal mode 0 from the power saving mode 2 based on the signal.

In S10, the sub CPU 41 performs a processing of shifting from the power saving mode 1 (mode 1) to the power saving mode 3 (mode 3). To be more specific, the sub CPU 41 requires the CPU 10, the ASIC 20, the RAM 30, the ROM 50, and the NVRAM 60 to shift to the OFF state. The CPU 10, the ASIC 20, the RAM 30, the ROM 50, and the NVRAM 60 perform various types of setting processings for shifting to the OFF state. Thereafter, the sub CPU 41 transmits a signal for turning OFF the power to the switching circuits 80 through 83, counts up the cumulative value of the number of times the power of the CPU 10 is turned ON/OFF by 1 and moves a process to S11. Note that since the processing is required to be continued by the sub CPU 41, the ASIC 40 is kept to be in the sleep mode (Partial Sleep).

In S11, the sub CPU 41 monitors whether predetermined data has been received. To be more specific, the sub CPU 41 monitors whether predetermined data (for example, print data transferred from the network I/F 70) indicating that at least the CPU 10 is to be operated in the normal mode has been received. If the predetermined data has been received (S 11: YES), the sub CPU 41 moves a process to S12. If the predetermined data has not been received (S 11: NO), the sub CPU 41 continues monitoring.

It is to be noted that the monitoring condition is not limited to the above condition. The sub CPU 41 may monitor whether a user's operation of setting the normal mode has been accepted through the operation panel.

In S12, the sub CPU 41 performs a processing of shifting from the power saving mode 3 (mode 3) to the normal mode (mode 0). To be more specific, the sub CPU 41 transmits a signal for turning ON the power to the switching circuits 80 through 83 so as to require the ASIC 40 to shift to the ON state. When power is supplied to the CPU 10, the ASIC 20, the RAM 30, the ROM 50, and the NVRAM 60, the CPU 10, the ASIC 20, the RAM 30, the ROM 50, and the NVRAM 60 execute various types of start-up processings and shift to the ON state. Further, the ASIC 40 also executes the start-up processing and shifts to the ON state. After various types of devices have shifted to the ON state, the cumulative value of the number of times the power is turned ON/OFF in each of the sub CPU 41 and the CPU 10 is counted up by 1. Then, the sub CPU 41 and the CPU 10 shift to the sleep mode and return a process to S1.

Note that after various types of devices have shifted to the ON state, the ASIC 40 does not transmit a reset signal to the CPU 10. The CPU 10 can return to the ON state by the normal start-up processing. At this time, the CPU 10 may output information indicating that the CPU 10 has returned to the normal mode 0 from the power saving mode 3 to the operation panel. Note that since the CPU 10 executes a program from an initial state, the CPU 10 cannot distinguish the state from a case where power of the printer itself is turned ON from the OFF state. Then, for example, it is sufficient that the following method is employed. That is, the sub CPU 41 transmits a signal indicating that the CPU 10 has returned from the power saving mode 3 to the CPU 10. Then, the CPU 10 determines that the CPU 10 has returned to the normal mode 0 from the power saving mode 3 based on the signal.

### Operation Mode Example 2

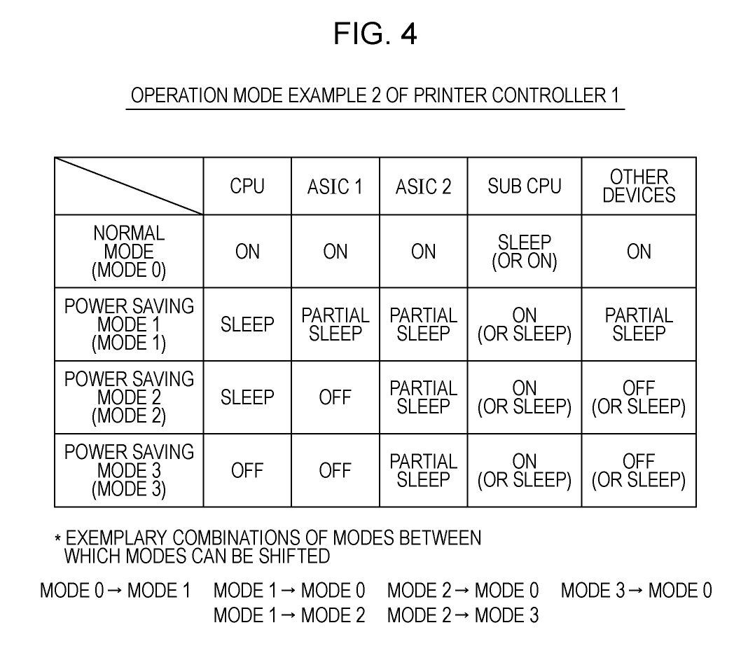

FIG. 4 is a diagram illustrating an Operation Mode Example 2 of the printer controller 1.

Each mode in the Operation Mode Example 2 as shown in FIG. 4 is the same as that in the Operation Mode Example 1 as shown in FIG. 2. However, combinations of modes between which modes can be shifted are partially different. The combinations of modes between which modes can be shifted are mode 0→mode 1, mode 1→mode 0, mode 1→mode 2, mode 2→mode 0, mode 2→mode 3, and mode 3→mode 0. In this Example, only the mode 2 can be shifted to the mode 3.

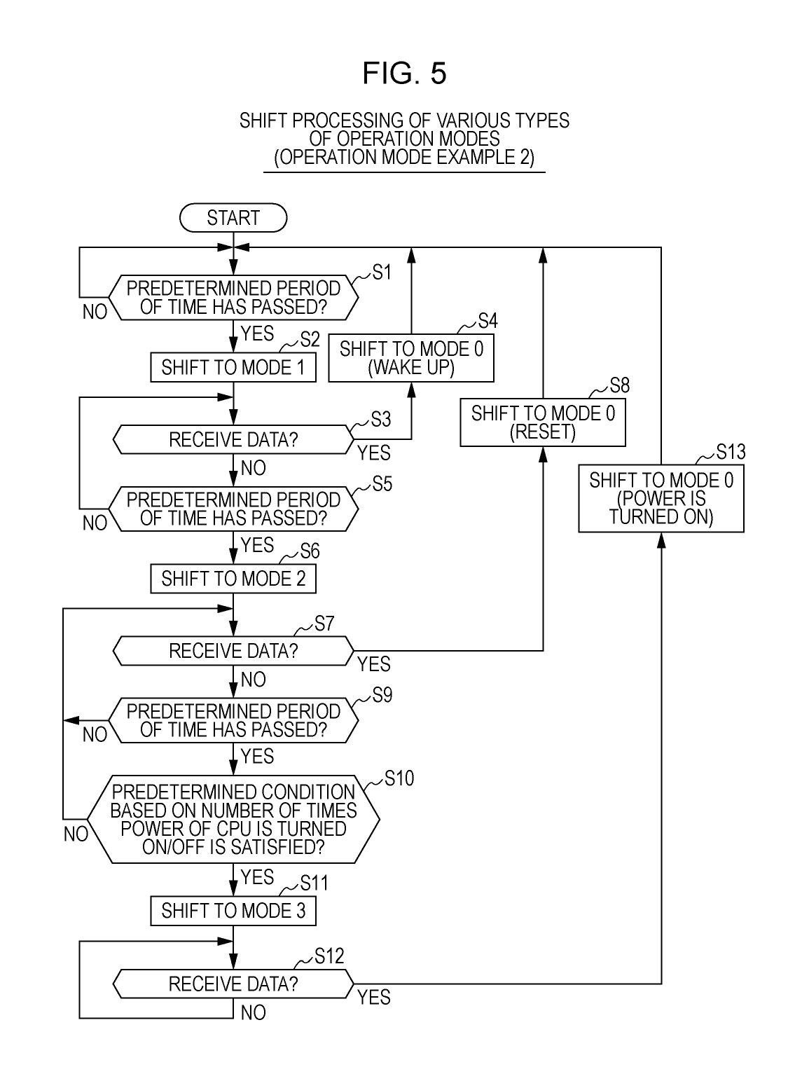

FIG. 5 is a flowchart illustrating a shift processing of various types of operation modes in the printer controller 1 in the Operation Mode Example 2. The flow is executed in the normal mode (mode 0) after the power of the printer has been turned ON and the printer is started-up. Hereinafter, points different from FIG. 3 are mainly described.

Since S1 through S5 are the same as S1 through S5 in FIG. 3, description thereof is not repeated.

In S6, the sub CPU 41 performs a processing of shifting from the power saving mode 1 (mode 1) to the power saving mode 2 (mode 2) and moves a process to S7. S6 is the same as S7 in FIG. 3 and detailed description thereof is not repeated.

In S7, the sub CPU 41 monitors whether predetermined data has been received. S7 is the same as S8 in FIG. 3 and detailed description thereof is not repeated. If the predetermined data has been received (S7: YES), the sub CPU 41 moves a process to S8. If the predetermined data has not received (S7: NO), the sub CPU 41 moves a process to S9.

S8 is the same as S9 in FIG. 3 and description thereof is not repeated.

In S9, the sub CPU 41 monitors whether a predetermined period of time has passed since the power saving mode 2 (mode 2) has been started. To be more specific, the sub CPU 41 monitors by using a timer whether a predetermined period of time (for example, 20 minutes) has passed since the mode shifted to the mode 2 from the mode 1. If the predetermined period of time has not passed (S9: NO), the sub CPU 41 returns a process to S7. If the predetermined period of time has passed (S9: YES), the sub CPU 41 moves a process to S10.

It is to be noted that the monitoring condition is not limited to the above condition. The sub CPU 41 may monitor whether a user's operation of setting the power saving mode 3 has been accepted through the operation panel.

In S10, the sub CPU 41 determines whether a predetermined condition based on the number of times the power of the CPU 10 is turned ON/OFF is satisfied. S10 is the same as S6 in FIG. 3 and detailed description thereof is not repeated. If the condition is satisfied (S10: YES), the sub CPU 41 moves a process to S11. If the condition is not satisfied (S 10: NO), the sub CPU 41 returns a process to S7.

S11 through S13 are the same as S10 through S12 in FIG. 3 and description thereof is not repeated.

Each of the above steps in FIG. 3 and FIG. 5 is a step obtained by dividing processings of the printer controller 1 depending on main processing contents in order to make the processings of the printer controller 1 understood easily. The invention is not limited by the division ways of steps and names of steps. Processings in the printer controller 1 can be divided into more steps in accordance with main processing contents. Further, the processings of the printer controller 1 can be divided such that many processings are included in one step.

### Modification of Operation Mode Examples 1 and 2

A determination processing of shifting from the mode 1 to the mode 3 in the Operation Mode Example 1 (S6 in FIG. 3), and a determination processing of shifting from the mode 2 to the mode 3 in the Operation Mode Example 2 (S10 in FIG. 5) may be as follows.

The printer controller 1 previously stores an upper limit value of the number of printable sheets in a range where reliability and operations of the printer are guaranteed. The upper limit value is recorded in the ROM 50 or the NVRAM 60 at the time of manufacturing the printer, for example. Further, the printer controller 1 records a cumulative value of the number of printed sheets where printing has actually been performed onto print media with the printer engine. A recording method is as follows. For example, it is sufficient that the CPU 10 monitors that the printing is executed, and the number of printings is accumulated in a storage region of the ROM 50 and the NVRAM 60.

By using the above various types of values, the sub CPU 41 calculates a ratio of a remaining number of printable sheets with respect to the upper limit value of the number of printable sheets (1−number of printed sheets/number of printable sheets) first, in a shift determination processing. Further, the sub CPU 41 calculates a ratio of a remaining number of times the power of the CPU 10 is turned ON/OFF with respect to the upper limit value of the number of times the power thereof is turned ON/OFF (1−cumulative value/upper limit value).

Then, the sub CPU 41 determines whether the calculated ratio of the remaining number of times the power of the CPU 10 is turned ON/OFF is larger than the calculated ratio of the remaining number of printable sheets (condition is satisfied). If the calculated ratio of the remaining number of times the power of the CPU 10 is turned ON/OFF is larger than the calculated ratio of the remaining number of printable sheets, the sub CPU 41 shifts the mode to the mode 3. If the calculated ratio of the remaining number of times the power of the CPU 10 is turned ON/OFF is not larger than the calculated ratio of the remaining number of printable sheets, the sub CPU 41 does not shift the mode to the mode 3.

With the above determination processing, when although the lifetime of the printer itself (number of printable sheets) is not enough, the lifetime of the CPU (the number of times the power is turned ON/OFF) is still enough, the power saving mode where the power of the CPU is turned OFF is used so as to realize power saving further. On the other hand, when although the lifetime of the printer itself is enough, the lifetime of the CPU is not enough, the power saving mode where the power of the CPU is turned OFF is not used and the lifetime of the CPU can be made longer.

As described above, an embodiment of the invention has been described. According to the embodiment, a technique of realizing both power saving and speeding-up of processings in the image processing apparatus more properly can be provided.

That is to say, in the embodiment, even if the CPU (CPU of which processing speed is faster) in which the number of times the power is turned ON/OFF is limited is employed as a controller, the power is not turned OFF in some of the power saving modes (mode 1 and mode 2). Therefore, increase in the number of times the power of the CPU is turned ON/OFF is limited as much as possible and the reliability of the operations of the CPU can be kept to be high for a longer period of time.

Further, in the embodiment, only when the predetermined condition based on the number of times the power of the CPU is turned ON/OFF is satisfied, the power of the CPU is turned OFF in the power saving mode (mode 3). With this, the power is easily limited to be turned OFF and the reliability of the operations of the CPU can be kept to be high for a longer period of time. In addition, since the power of the CPU is tuned OFF when the predetermined condition is satisfied, power saving can be made further.

Further, in the embodiment, a mode in which power saving is further realized (power saving mode 2) is provided in the embodiment. In the mode, although the power of the CPU is not turned OFF, power of some devices other than the CPU is set to be in the OFF state. Therefore, the lifetime of the CPU of which the number of times the power is turned ON/OFF is limited can be made longer while power saving can be further realized. Further, a mode in which power saving is further realized (power saving mode 3) is provided in the embodiment. In the mode, power of the CPU and some devices other than the CPU is set to be in the OFF state. With this, power saving can be further realized.

Further, in the embodiment, a signal line connecting the ASIC (ASIC 20) which performs access control of the RAM to the CPU is pulled up. This makes it possible to prevent a wake-up signal from being mistakenly input to the CPU when the power of the ASIC is turned OFF and prevent the CPU from waking up from the sleep mode.

In addition, in the embodiment, the ASIC (ASIC 20) which performs access control of the RAM does not transmit a wake-up signal to the CPU when returning to the ON state from the power OFF state. Instead, the sub CPU which controls returning to the normal mode from the power saving mode transmits a reset signal to the CPU. Therefore, since the CPU can start to execute a program from an initial state, the controller can be operated normally even if the ASIC is initialized by turning ON the power source. If the wake-up signal is used, a state of the ASIC initialized by turning ON the power and a state of the CPU (program) started up from the sleep mode are difficult to be consistent with each other. This may cause the controller to hang up.

Further, in the embodiment, the mode can shift to the power saving mode (the power saving mode 2 and the mode 3) only through the power saving mode (power saving mode 1). In the power saving mode (the power saving mode 2 and the mode 3), power of some devices other than the CPU (the ASIC 20, the RAM 30, the ASIC 40, the ROM 50, the NVRAM 60 and the like) is turned OFF. In the power saving mode (power saving mode 1), some devices other than the CPU are made to be in the sleep mode. Therefore, various types of devices never suddenly shift to the power OFF state from the power ON state. This makes it possible to reduce a load imposed onto devices with concern for deterioration in reliability due to the increase in the number of times the power is turned ON/OFF. As a result, the reliability of the operations of the entire controller can be kept to be high for a longer period of time. Further, failure rate can be decreased for a longer period of time.

There is an existing system having a power saving mode where power of most devices including the CPU on the controller is turned OFF. However, in such system, it is difficult to employ a CPU of which number of times the power is turned ON/OFF is limited. Further, in a CPU of which number of times the power is turned ON/OFF is not limited or moderately limited, the processing speed tends to be slower or cost tends to be higher in comparison with the CPU of which number of times the power is turned ON/OFF is limited. Therefore, the CPU of which number of times the power is turned ON/OFF is not limited or moderately limited cannot realize a preferable balance in the conditions other than the condition that the number of times the power is turned ON/OFF is limited.

Under the above circumstances, if the invention is employed, a CPU of which number of times the power is turned ON/OFF is limited can be used in the power saving mode without turning OFF the power source. Further, the power of the CPU is turned OFF only when a specified condition is satisfied. In addition, power of the ASIC connected to the CPU and of other devices can be turned OFF in the power saving mode. That is to say, if the invention is employed, a CPU of which processing speed is faster and which is not expensive can be used in the controller, and power consumption of the image processing apparatus and the controller can be entirely reduced. Further, by using the CPU of which processing speed is faster in the controller, the period of time where the power consumption of the image processing apparatus (for example, printing processing, or copying processing) is high can be shortened and the entire power consumption can be reduced. Thus, both power saving and high performance can be realized in a balanced manner.

Note that the above embodiment of the invention is intended to illustrate the spirit and the scope of the invention and is not intended to limit the invention. It is apparent for those skilled in the art that various alternatives, changes, and modifications can be made.

For example, the printer controller 1 may be configured such that the printer controller 1 can be shifted to the power saving mode 2 or the power saving mode 3 from the normal mode not through the power saving mode 1 in the Operation Mode Examples 1 and 2. Further, in the Operation Mode Examples 1 and 2, the printer controller 1 may be configured to have three modes of the normal mode, the power saving mode 2, and the power saving mode 3. In addition, a mode where power consumption is smaller than that in the power saving mode 1 and power consumption is larger than that in the power saving mode 2 may be provided between the power saving mode 1 and the power saving mode 2.

Further, for example, the sub CPU 41 may not be required to be in the ON state in the power saving mode 1, the power saving mode 2, and the power saving mode 3, but wait in the sleep state. At this time, the sub CPU 41 may return to the ON state when predetermined data is received from the network I/F 70 or the operation panel.

In addition, for example, as for the shift to the normal mode (mode 0) from the power saving mode 2 (mode 2), the sub CPU 41 may be configured so as to transmit a reset signal to the CPU 10 continuously before shifting and stop (cancel) the transmission of the reset signal at the time of shifting to the mode 0. “Before shifting” may mean that the shift is a timing after the mode 2 is started or after the mode is determined to shift to the mode 0, for example. “At the time of shifting to the mode 0” may mean that it is a timing where the CPU 10 is not malfunctioned in consideration of processing of switching of the devices such as the ASIC 40 to the ON state. With such configuration, the CPU 10 can be returned to the ON state through the reset state.

It is to be noted that the “ASIC” in the specification is not limited to the name and function thereof and may be a “processor” or a “controller.”

The entire disclosure of Japanese Patent Application No. 2009-231877, filed Oct. 5, 2009 and No. 2010-120090, filed May 26, 2010 are expressly incorporated by reference herein.

What is claimed is:

1. A controller for an image processing apparatus, which has a function of switching a plurality of operation modes, comprising:
a CPU of which number of times the power is turned ON/OFF in a range where operations are guaranteed is previously defined;
a processor which performs a specified processing;
a sub CPU; and
other devices,
the controller having a normal mode, a first power saving mode in which the power consumption is smaller than that in the normal mode, a second power saving mode in which the power consumption is smaller than that in the first power saving mode, and a third power saving mode in which the power consumption is smaller than that in the second power saving mode,
wherein in the normal mode, the CPU, the processor and the other devices are in an ON state where each normal function can be executed, and the sub CPU is in a sleep state in which the power consumption is smaller than that in the ON state,
in the first power saving mode, the CPU is in the sleep state, at least one of the processor and the other devices is in the sleep state, and the sub CPU is in the ON state,
in the second power saving mode, the CPU is in the sleep state, the processor and the other devices are in a power OFF state, and the sub CPU is in the ON state,
in the third power saving mode, the CPU is in the power OFF state, the processor and the other devices are in the power OFF state, and the sub CPU in the ON state,
the CPU controls switching from the normal mode to the first power saving mode,
the sub CPU controls switching from the first power saving mode to the normal mode, switching from the first power saving mode to the second power saving mode or the third power saving mode, and switching from the second power saving mode or the third power saving mode to the normal mode, and
the sub CPU determines whether to switch from the first power saving mode to either of the second power saving mode or the third power saving mode in accordance with a cumulative number of times the power of the CPU is turned ON/OFF.

2. The controller for the image processing apparatus according to claim 1,
wherein the sub CPU determines whether the cumulative number of times the power of the CPU is turned ON/OFF is not larger than a predetermined number, and if the cumulative number of times is not larger than the predetermined number, the sub CPU switches from the first power saving mode to the second power saving mode, and if the cumulative number of times is larger than the predetermined number, the sub CPU switches from the first power saving mode to the third power saving mode.

3. The controller for the image processing apparatus according to claim 1,
wherein the image processing apparatus is a print apparatus,
the sub CPU calculates a ratio of a remaining number of times the power of the CPU is turned ON/OFF as a first ratio by using the cumulative number of times the power of the CPU is turned ON/OFF and the number of times the power of the CPU is turned ON/OFF in a range where operations are guaranteed, and calculates a ratio of a remaining number of printable sheets as a second ratio by using a cumulative number of printed sheets and a predetermined number of printable sheets,
the sub CPU determines whether the first ratio is larger than the second ratio, and
if the first ratio is larger than the second ratio, the sub CPU switches from the first power saving mode to the third power saving mode, and if the first ratio is not larger than the second ratio, the sub CPU switches from the first power saving mode to the second power saving mode.

4. A controller for an image processing apparatus, which has a function of switching a plurality of operation modes, comprising:
a CPU of which number of times the power is turned ON/OFF in a range where operations are guaranteed is previously defined;
a processor which performs a specified processing;
a sub CPU; and
other devices,
the controller having a normal mode, a second power saving mode in which the power consumption is smaller than that in the normal mode, and a third power saving mode in which the power consumption is smaller than that in the second power saving mode,
wherein in the normal mode, the CPU, the processor and the other devices are in an ON state where each normal function can be executed, and the sub CPU is in a sleep state in which the power consumption is smaller than that in an ON state,
in the second power saving mode, the CPU is in the sleep state, the processor and the other devices are in a power OFF state, and the sub CPU is in the ON state,
in the third power saving mode, the CPU is in the power OFF state, the processor and the other devices are in the power OFF state, and the sub CPU is in the ON state,
the CPU controls switching from the normal mode to the second power saving mode,
the sub CPU controls switching from the second power saving mode to the normal mode, switching from the second power saving mode to the third power saving mode, and switching from the third power saving mode to the normal mode, and
the sub CPU determines whether to continue the second power saving mode or switch from the second power saving mode to the third power saving mode in accordance with a cumulative number of times the power of the CPU is turned ON/OFF.

5. The controller for the image processing apparatus according to claim 4,
wherein the sub CPU determines whether the cumulative number of times the power of the CPU is turned ON/OFF is not larger than a predetermined number, and if the cumulative number of times is not larger than the predetermined number, the sub CPU switches from the second power saving mode to the third power saving mode, and if the cumulative number of times is larger than the predetermined number, the sub CPU continues the second power saving mode.

6. The controller for the image processing apparatus according to claim 4,
wherein the image processing apparatus is a print apparatus,
the sub CPU calculates a ratio of a remaining number of times the power of the CPU is turned ON/OFF as a first ratio by using the cumulative number of times the power of the CPU is turned ON/OFF and the number of times the power of the CPU is turned ON/OFF in a range where operations are guaranteed, and calculates a ratio of a remaining number of printable sheets as a second ratio by using a cumulative number of printed sheets and a predetermined number of printable sheets,
the sub CPU determines whether the first ratio is larger than the second ratio, and
if the first ratio is larger than the second ratio, the sub CPU switches from the second power saving mode to the third power saving mode, and if the first ratio is not larger than the second ratio, the sub CPU continues the second power saving mode.

7. The controller for the image processing apparatus according to claim 1,
wherein the sub CPU transmits a reset signal to the CPU when switching from the second power saving mode to the normal mode.

8. The controller for the image processing apparatus according to claim 1,
wherein the CPU and the processor are connected to each other with a signal line for inputting an interrupt signal to the CPU, and
an input terminal of the interrupt signal on the CPU is pulled up.
